(19) United States
(12) Patent Application Publication
(10) Pub. No.: US 2014/0000030 A1
(43) Pub. Date: Jan. 2, 2014

(54) LIFT SYSTEM FOR A PERSON SUPPORT APPARATUS

(71) Applicant: Hill-Rom Services, Inc., Batesville, IN (US)

(72) Inventors: Bradley Michael Robertson, Harrison, OH (US); Brian Guthrie, Greensburg, IN (US)

(73) Assignee: Hill-Rom Services, Inc., Batesville, IN (US)

(21) Appl. No.: 13/918,434

(22) Filed: Jun. 14, 2013

Related U.S. Application Data
(60) Provisional application No. 61/661,231, filed on Jun. 18, 2012.

(51) Int. Cl. A61G 7/012

(52) U.S. Cl. CPC A61G 7/012
USPC 5/611

(57) ABSTRACT

A person support apparatus comprises a lower frame, an upper frame, and a lift system. The upper frame is configured to support a person. The lift system is coupled to the lower frame and the upper frame and is configured to move the upper frame with respect to the lower frame at a first speed when the person on the upper frame is below a predetermined weight and move the upper frame with respect to the lower frame at second speed when the person is above the predetermined weight.

### BACKGROUND OF THE DISCLOSURE

This disclosure relates to lift systems for person support apparatuses. More particularly, but not exclusively, one contemplated embodiment relates to a lift system configured to raise the upper frame with respect to the lower frame at two different speeds depending on the amount of weight supported on the upper frame. While various lift systems have been developed, there is still room for improvement. Thus, a need persists for further contributions in this area of technology.

### SUMMARY OF THE DISCLOSURE

In one contemplated embodiment, a person support apparatus comprises a lower frame, an upper frame configured to support a person, and a lift system. The lift system is coupled to the lower frame and the upper frame and is configured to move the upper frame with respect to the lower frame at a first speed when the person on the upper frame is below a predetermined weight and move the upper frame with respect to the lower frame at second speed when the person is above the predetermined weight.

In another contemplated embodiment, a person support apparatus comprises a lower frame, an upper frame configured to support a person, a user input, a lift device, and a lift driver. The user input is coupled to the lower frame and is configured to be manually actuated. The lift device is coupled to the lower frame and the upper frame and is configured to expand and contract to move the lower frame with respect to the upper frame as a function of an input from the user input. The lift driver is coupled to the user input and the lift device. The lift driver is configured to cause the lift device to expand a first distance when a person below a predetermined weight is supported on the upper frame and expand a second distance when a person above a predetermined weight is supported on the upper frame, wherein the first distance is greater than the second distance.

In another contemplated embodiment, a person support apparatus comprises a lower frame, an upper frame configured to support a person, a user input, a lift device, and a lift driver. The user input is coupled to the lower frame and is configured to be manually actuated. The lift device is coupled to the lower frame and the upper frame and is configured to expand and contract to move the lower frame with respect to the upper frame as a function of an input from the user input. The lift driver is coupled to the user input and the lift device. The lift driver is configured to cause the lift device to move the upper frame from a first height to a second height when the user input is actuated a first number of times when the weight of the person is below a predetermined threshold and to move the upper frame from the first height to the second height when the user input is actuated a second number of times when the weight of the person is above the predetermined threshold.

Additional features, which alone or in combination with any other feature(s), such as those listed above and/or those listed in the claims, may comprise patentable subject matter and will become apparent to those skilled in the art upon consideration of the following detailed description of various embodiments exemplifying the best mode of carrying out the embodiments as presently perceived.

### BRIEF DESCRIPTION OF THE DRAWINGS

Referring now to the illustrative examples in the drawings, wherein like numerals represent the same or similar elements throughout:

FIG. 1 is a perspective side view of a person support apparatus according to one contemplated embodiment;

FIG. 2 is a side view of the person support apparatus of FIG. 1 showing the foot pedal;

FIG. 3 is a block diagram of the lift system for the person support apparatus of FIG. 1; and

FIG. 4 is a perspective side view of the lift driver according to one contemplated embodiment of the current disclosure.

### DETAILED DESCRIPTION OF THE DRAWINGS

While the present disclosure can take many different forms, for the purpose of promoting an understanding of the principles of the disclosure, reference will now be made to the embodiments illustrated in the drawings, and specific language will be used to describe the same. No limitation of the scope of the disclosure is thereby intended. Various alterations, further modifications of the described embodiments, and any further applications of the principles of the disclosure, as described herein, are contemplated.

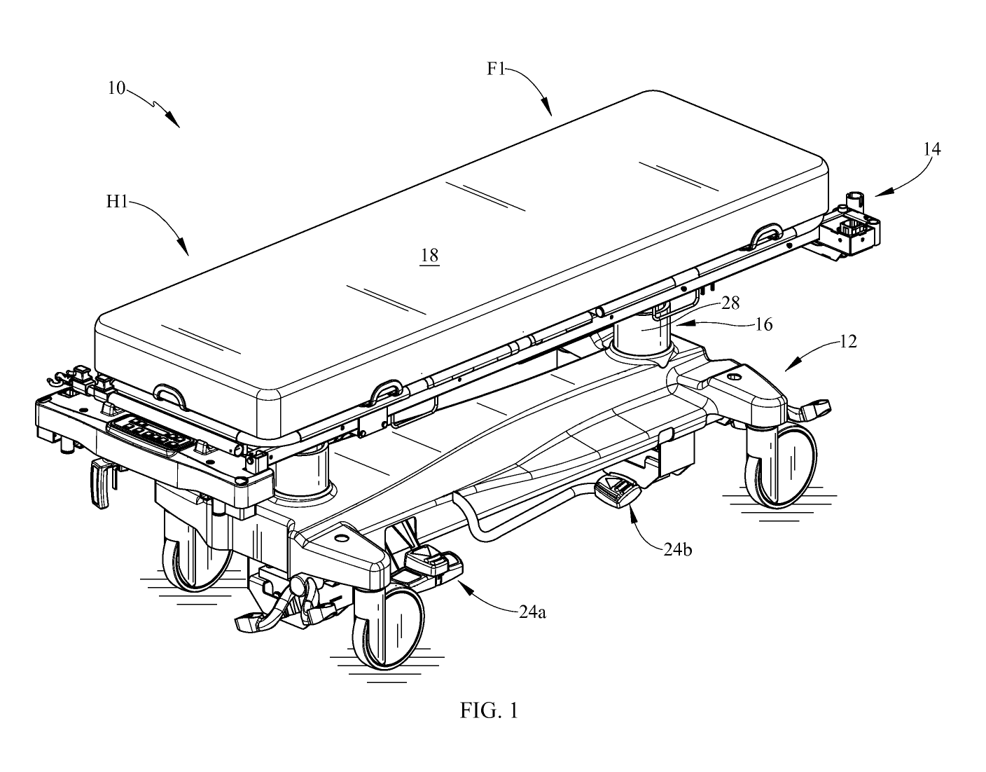

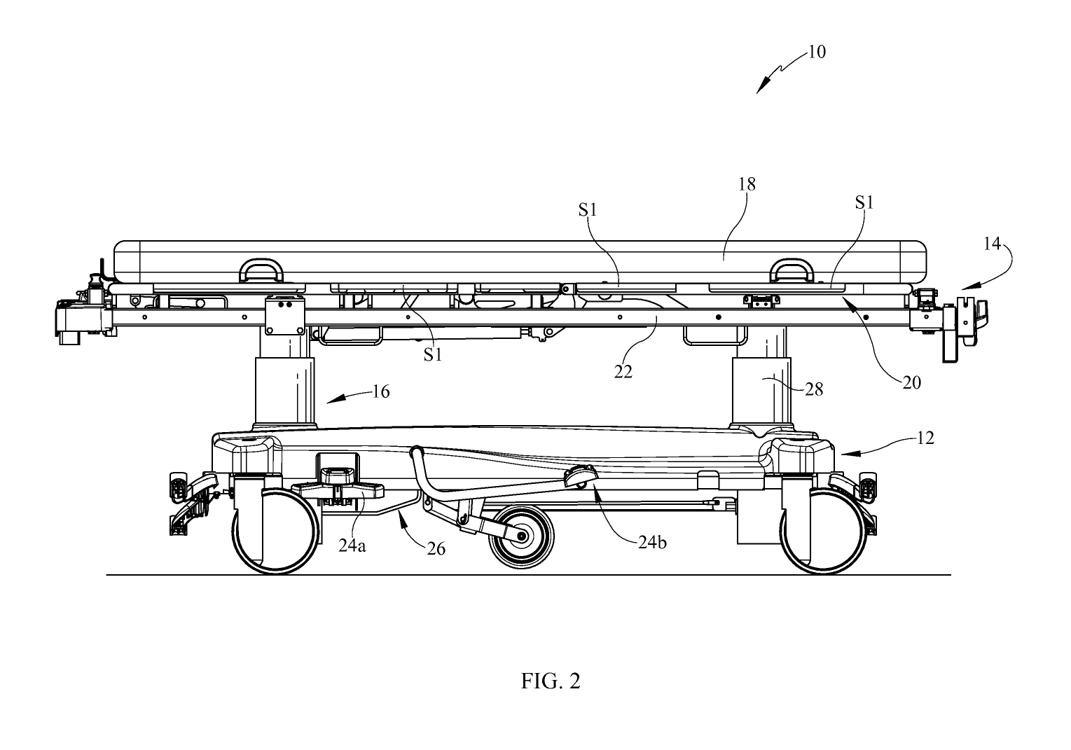

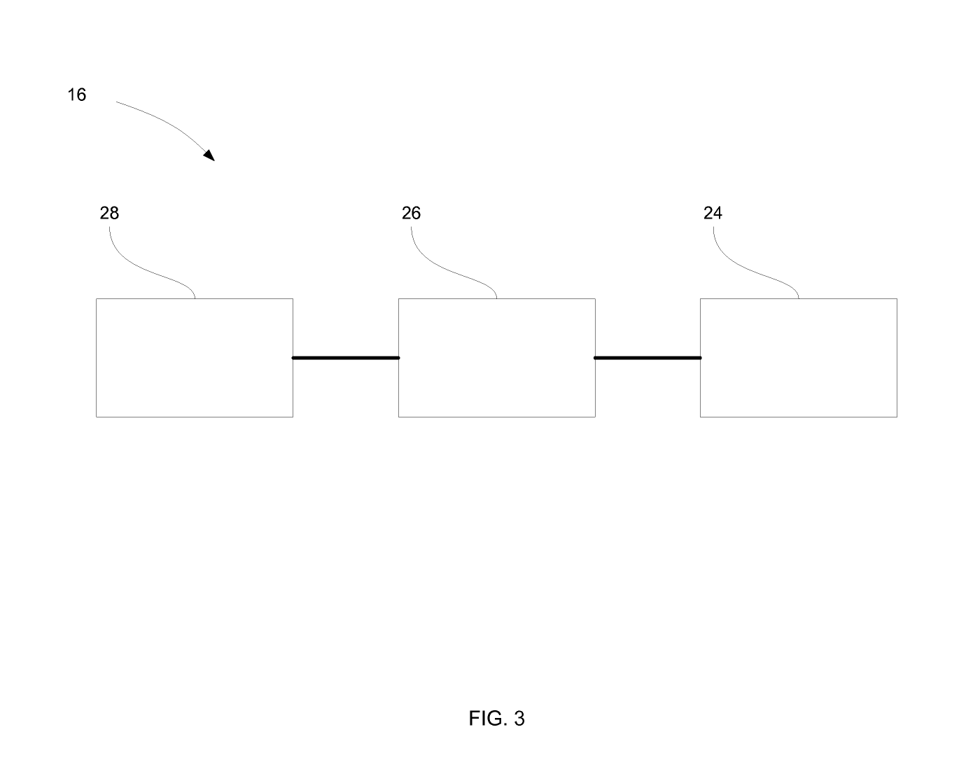

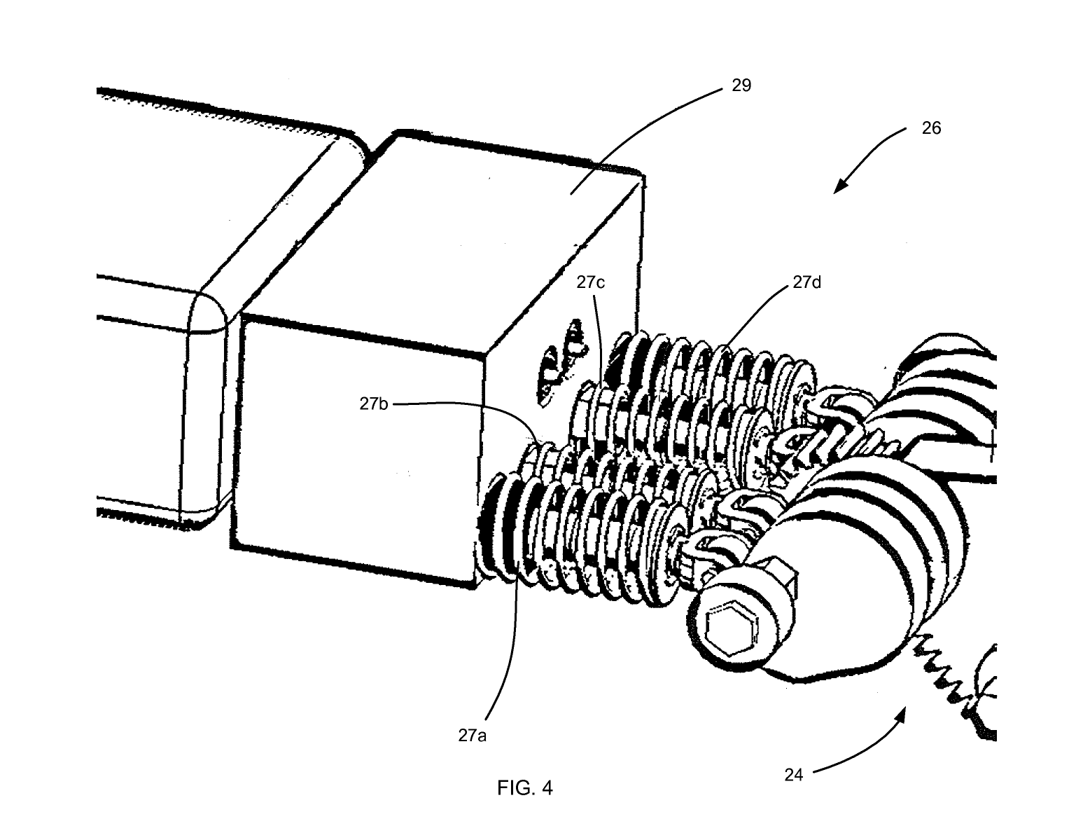

A person support apparatus 10 according to one illustrative embodiment of the current disclosure is shown in FIGS. 1-4. In some contemplated embodiments, the person support apparatus 12 is a stretcher and includes a head section H1, where the head of a person (not shown) is positioned, and a foot section F1, where the feet of a person (not shown) are positioned. In other contemplated embodiments, the person support apparatus 12 can be a hospital bed frame, an operating room table, or other person supporting structure. The person support apparatus 10 includes a lower frame 12 or base 12, an upper frame 14, and a lift system 16 coupled to the upper frame 14 and the lower frame 12. In some contemplated embodiments, the person support apparatus 10 supports a person support surface 18 or mattress 18 on the upper frame 14.

The upper frame 14 includes a deck 20 supported by an upper frame base 22. In some contemplated embodiments, the upper frame 14 also includes a footboard (not shown), a head board (not shown), and side rails (not shown) that are supported by the upper frame base 22. The deck 20 is comprised of multiple sections S1 that are configured to move with respect to the upper frame base 22 and one another to support a person on the upper frame 14 in multiple articulated positions.

The lift system 16 is configured to manually raise and lower the upper frame 14 with respect to the lower frame 12. The lift system 16 includes input devices 24, a lift driver 26, and two lift devices 28. The input devices 24 are configured to receive a manual input from a user that causes the lift driver 26 to actuate the lift devices 28. In one contemplated embodiment, the input devices 24 include lowering pedals 24a and a raising pedal 24b. The lowering pedals 24a are coupled to the lower frame 12 and are configured to cause the lift driver 26 to allow the lift devices 28 to retract and lower the upper frame 14 with respect to the lower frame 12. In some contemplated embodiments, if only one of the lowering pedals 24a is actuated, the upper frame 14 can be moved to a Trendelenburg or reverse Trendelenburg position. The raising pedal 24b is rotatably coupled to the lower frame 12 and configured to be pressed down (pumped) by a user to raise the upper frame 14 with respect to the lower frame 12.

The lift driver 26 is coupled to the lower frame and is in fluid communication with the lift devices 28. The lift driver 26 is configured to cause the lift devices 28 to expand and contract as a function of the input from the input device 22 and the load supported on the upper frame 14. In one contemplated embodiment, the lift driver 26 is configured to cause the lift devices 28 to expand a first distance for each pump of the raising pedal 24b when the load supported on the upper frame is less than a predetermined threshold, and expand a second distance for each pump of the raising pedal 24b when the load is above the predetermined threshold, wherein the first distance is greater than the second distance. In some contemplated embodiments, the lift driver 26 includes a cylinder, single piston, and valve construction, such as, the cylinder, piston, and valve construction disclosed in U.S. Pat. No. 2,621,019 to Mueller, which is hereby incorporated by reference. In other contemplated embodiments, the lift driver 26 includes four pistons 27a-e connected to the raising pedal 24b, and a fluid circuit 29 configured to receive the pistons 27a-e and cause the lift devices 28 to raise and lower as a function of the activation of the pistons 27. In one contemplated embodiment, the fluid circuit 29 is a hydraulic circuit configured to actuate hydraulic lift devices 28. The four pistons are arranged such that two of the pistons (i.e., 27b and 27c) interface with a high pressure, low volume section of the fluid circuit 29, and the other two pistons (i.e., 27a and 27b) interface with a low pressure, high volume section of the fluid circuit 29. The fluid circuit 29 includes relief valves (not shown) in communication with the low pressure, high volume section of the fluid circuit, which open when the pressure in the low pressure, high volume section reaches a predetermined level (i.e., when the upper frame 14 supports a predetermined load). The opening of the relief valves effectively negate the input provided by the low pressure, high volume section until the pressure in the section drops below the predetermined level. By increasing the amount of fluid communicated to the lift devices 28 when the upper frame 14 supports less than a predetermined load (i.e., when a person is not supported thereon), the distance the lift device expands for each pump of the raising pedal 24b is increased and the upper frame 14 is raised at a faster rate (i.e., 2×) than when the upper frame supports more than the predetermined load.

The lift devices 28 are coupled to the lower frame 12 and the upper frame and expand and contract to raise and lower the upper frame 14 with respect to the lower frame 12. In some contemplated embodiments, the lift devices 28 are hydraulic linear actuators. In other contemplated embodiments, the lift devices 28 can include a scissor lift mechanism (not shown) that is urged by an actuator (not shown) in fluid communication with the lift driver 26. In some contemplated embodiments, the lift devices 26 are configured to cooperate with the lift driver 26 to move the upper frame 14 from its lowest vertical height to its highest vertical height with respect to the lower frame 12 in a first amount of pumps of the raising pedal 24b when the load is less than a predetermined threshold and a second amount of pumps when the load is above the predetermined threshold, wherein the second amount of pumps is about twice as many as the first amount of pumps.

Many other embodiments of the present disclosure are also envisioned. For example, a person support apparatus comprises a lower frame, an upper frame configured to support a person, and a lift system. The lift system is coupled to the lower frame and the upper frame and is configured to move the upper frame with respect to the lower frame at a first speed when the person on the upper frame is below a predetermined weight and move the upper frame with respect to the lower frame at second speed when the person is above the predetermined weight.

In another example, a person support apparatus comprises a lower frame, an upper frame configured to support a person, a user input, a lift device, and a lift driver. The user input is coupled to the lower frame and is configured to be manually actuated. The lift device is coupled to the lower frame and the upper frame and is configured to expand and contract to move the lower frame with respect to the upper frame as a function of an input from the user input. The lift driver is coupled to the user input and the lift device. The lift driver is configured to cause the lift device to expand a first distance when a person below a predetermined weight is supported on the upper frame and expand a second distance when a person above a predetermined weight is supported on the upper frame, wherein the first distance is greater than the second distance.

In another example, a person support apparatus comprises a lower frame, an upper frame configured to support a person, a user input, a lift device, and a lift driver. The user input is coupled to the lower frame and is configured to be manually actuated. The lift device is coupled to the lower frame and the upper frame and is configured to expand and contract to move the lower frame with respect to the upper frame as a function of an input from the user input. The lift driver is coupled to the user input and the lift device. The lift driver is configured to cause the lift device to move the upper frame from a first height to a second height when the user input is actuated a first number of times when the weight of the person is below a predetermined threshold and to move the upper frame from the first height to the second height when the user input is actuated a second number of times when the weight of the person is above the predetermined threshold.

Any theory, mechanism of operation, proof, or finding stated herein is meant to further enhance understanding of principles of the present disclosure and is not intended to make the present disclosure in any way dependent upon such theory, mechanism of operation, illustrative embodiment, proof, or finding. It should be understood that while the use of the word preferable, preferably or preferred in the description above indicates that the feature so described may be more desirable, it nonetheless may not be necessary and embodiments lacking the same may be contemplated as within the scope of the disclosure, that scope being defined by the claims that follow.

In reading the claims it is intended that when words such as “a,” “an,” “at least one,” “at least a portion” are used there is no intention to limit the claim to only one item unless specifically stated to the contrary in the claim. When the language “at least a portion” and/or “a portion” is used the item may include a portion and/or the entire item unless specifically stated to the contrary.

It should be understood that only selected embodiments have been shown and described and that all possible alternatives, modifications, aspects, combinations, principles, variations, and equivalents that come within the spirit of the disclosure as defined herein or by any of the following claims are desired to be protected. While embodiments of the disclosure have been illustrated and described in detail in the drawings and foregoing description, the same are to be considered as illustrative and not intended to be exhaustive or to limit the disclosure to the precise forms disclosed. Additional alternatives, modifications and variations may be apparent to those skilled in the art. Also, while multiple inventive aspects and principles may have been presented, they need not be utilized in combination, and various combinations of inventive aspects and principles are possible in light of the various embodiments provided above.

What is claimed is:

1. A person support apparatus, comprising:
a lower frame;
an upper frame configured to support a person;
a lift system coupled to the lower frame and the upper frame and configured to move the upper frame with respect to the lower frame at one of a first speed and a second speed depending on the weight of the person supported on the upper frame relative to a predetermined threshold.

2. The person support apparatus of claim 1, wherein the first speed is twice as fast as the second speed.

3. The person support apparatus of claim 1, wherein the predetermined threshold is greater than 100 lbs.

4. The person support apparatus of claim 1, wherein the upper frame includes an upper frame base and a deck supported on the upper frame base, the deck including at least two deck sections configured to move with respect to the upper frame and one another between a first substantially planar position and a second articulated position.

5. The person support apparatus of claim 1, wherein the lift system includes a manual input coupled to the lower frame.

6. A person support apparatus, comprising:
a lower frame;
an upper frame configured to support a person;
a user input coupled to the lower frame and configured to be manually actuated;
a lift device coupled to the lower frame and the upper frame and configured to expand and contract to move the upper frame with respect to the lower frame as a function of an input from the user input; and
a lift driver coupled to the user input and the lift device, the lift driver being configured to cause the lift device to expand a first distance when a person below about a predetermined weight is supported on the upper frame and expand a second distance when a person above about the predetermined weight is supported on the upper frame, wherein the first distance is greater than the second distance.

7. The person support apparatus of claim 6, wherein the first distance is about twice the magnitude of the second distance.

8. A person support apparatus, comprising:
a lower frame;
an upper frame configured to support a person;
a user input coupled to the lower frame and configured to be manually actuated;
a lift device coupled to the lower frame and the upper frame and configured to expand and contract to move the lower frame with respect to the upper frame as a function of an input from the user input; and
a lift driver coupled to the user input and the lift device, the lift driver being configured to cause the lift device to move the upper frame from a first height to a second height upon actuation of the user input a first number of times when the weight of the person is below a predetermined threshold, and to move the upper frame from the first height to the second height upon actuation of the user input a second number of times when the weight of the person is above the predetermined threshold, wherein the first number of times is less than the second number of times.

9. The person support apparatus of claim 8, wherein the second number of times is twice the number of times.

10. The person support apparatus of claim 8, wherein the first number of times is about 15 full strokes.

11. The person support apparatus of claim 8, wherein the lift driver includes a plurality of input pistons configured to engage a fluid circuit including a high pressure, low volume section and a low pressure, high volume section.

12. The person support apparatus of claim 11, wherein two of the plurality of input pistons engage the high pressure, low volume section and two of the plurality of input pistons engage the low pressure, high volume section.

13. The person support apparatus of claim 8, wherein the lift driver includes a fluid circuit including a high pressure, low volume section and a high volume, low pressure section and at least one pressure relief valve in communication with the high volume, low pressure section.
